(19) United States
(12) Patent Application Publication
(10) Pub. No.: US 2023/0046076 A1
(43) Pub. Date: Feb. 16, 2023

(54) Fish Filet Accessory Device

(71) Applicant: John Trout, Woodbine, NJ (US)

(72) Inventor: John Trout, Woodbine, NJ (US)

(21) Appl. No.: 17/547,915

(22) Filed: Dec. 10, 2021

Related U.S. Application Data
(60) Provisional application No. 63/231,313, filed on Aug. 10, 2021.

(51) Int. Cl. A22C 25/00

(52) U.S. Cl. CPC A22C 25/006

(57) ABSTRACT

The present invention is comprised of a fish filet device comprised of a body further comprised of a first end and a second end, a grip and a wrist strap. The wrist strap can be secured around the wrist of the user during use, such that the device cannot be dropped. The second end is further comprised of a plurality of teeth that can be used to secure the device into the skin of a fish. In this manner, a user can press the device into a fish using his or her non-dominant hand, in order to secure the fish and prevent the fish body from sliding on a cutting surface, while fileting the fish with a knife in his or her dominant hand.

### CROSS REFERENCE TO RELATED APPLICATION

The present application claims priority to, and the benefit of, U.S. Provisional Application No. 63/231,313, which was filed on Aug. 10, 2021 and is incorporated herein by reference in its entirety.

### FIELD OF THE INVENTION

The present invention relates generally to the field of fish preparation tools. More specifically, the present invention comprises a fish filet accessory device primarily comprised of a body having a first end and a second end, a grip and a wrist strap. The wrist strap can be secured around the wrist of a user during use, such that the device cannot be dropped. In this manner, a user can press the device into a fish using his or her non-dominant hand, in order to secure the fish and prevent the fish body from sliding on a cutting surface, while fileting the fish with a knife in his or her dominant hand. Accordingly, the present disclosure makes specific reference thereto. Nonetheless, it is to be appreciated that aspects of the present invention are also equally applicable to other like applications, devices and methods of manufacture.

### BACKGROUND

Many individuals enjoy fishing as a hobby, and regularly eat and prepare the fish they catch. Other individuals may purchase whole fish from food markets or grocery stores. However, preparing a whole fish for cooking requires a set of very tedious and specific skills. Said skills include scaling and filleting the fish. Fish are often extremely slippery, especially after being out of water. This proves to be a difficult problem when attempting to cut or filet the fish with precision, in anticipation of cooking the fish. As a result of a fish’s slippery skin on a cutting surface, a user may lose his or her grip of the fish and/or knife while attempting to filet the fish, such that he or she accidently cuts and injures him or herself with said knife. In addition, a user may drop a knife and injure him or herself or other nearby individuals.

Therefore, there exists a long-felt need in the art for an improved fish preparation tool. There also exists a long-felt need in the art for a fish filet device that allows a user to more easily and securely control a fish, while attempting to filet said fish. Additionally, there exists a long-felt need in the art for a fish filet device that is securely retained on the user, such that the device cannot easily slip out of a user’s hand during use.

The subject matter disclosed and claimed herein, in one embodiment thereof, comprises a fish filet device. The device is primarily comprised of a body that is further comprised of a first end and a second end, a grip and a wrist strap. The first end is further comprised of an end cap that allows a wrist strap to attach to the device. The wrist strap can be secured around the wrist of the user during use, such that the device cannot be dropped. The second end is further comprised of a plurality of teeth that can be used to secure the device into the skin of a fish that is being fileted. In this manner, a user can press the device into the fish using his or her non-dominant hand, in order to secure the fish and prevent the fish body from sliding on a cutting surface, while fileting the fish with a knife in his or her dominant hand.

In this manner, the fish filet device of the present invention accomplishes all of the forgoing objectives and provides an improved device that can be used while preparing a fish. Further, the device creates one or multiple points of contact with the fish to allow a user to control the fish during the fileting process. As a result, a user is less likely to accidently cut himself or herself while fileting the fish, as the fish can no longer slide on the cutting surface. In addition, the device is secured to the wrist of the user via the wrist strap, such that it cannot be dropped.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fish filet device. The device is primarily comprised of a body that is further comprised of a first end and a second end, a grip and a wrist strap. The first end is further comprised of a removable or fixedly-attached cap that is comprised of a fixedly-attached loop. The loop can further receive a clip of a wrist strap to allow the strap to removably attach to the loop. The strap is also comprised of an adjustable fastener such as a buckle, snap-button, hook and loop surface, etc., that allows the looped body of the strap to tighten or loosen around the wrist of a user. As a result, the strap secures the device to a user, such that the device cannot be dropped during use. The second end is further comprised of a removable or fixedly-attached cap that has a plurality of teeth. The teeth are preferably comprised of a durable metal, such as stainless steel or aluminum, and may be fixedly-attached or removable (to allow for cleaning) from the bottom surface of the cap. In addition, the teeth may be serrated or non-serrated.

To use the device, a user grasps the device via the grip with the non-dominant hand. Then, the user thrusts the teeth of the second end into the skin of a fish. A user can then maintain pressure on the fish using the device, such that the fish cannot move upon the cutting surface it is resting on. With the fish secured, a user can then use a knife to filet the fish as desired, without having to worry about the fish moving during cutting.

Accordingly, the fish filet device of the present invention is particularly advantageous, as it provides an improved tool to aid in the preparation of fish. Further, the device ensures a user can secure a fish during the fileting process to prevent the fish from moving. As a result, the chance of a fish slipping on a cutting surface is greatly reduced, which then reduces the possibility of a user accidently cutting him or herself with a knife used to cut/filet the fish.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the fish filet accessory device of the present invention in accordance with the disclosed architecture;

FIG. 2 illustrates an enhanced perspective view of the pronged end of one potential embodiment of the fish filet accessory device of the present invention in accordance with the disclosed architecture;

FIG. 3 illustrates a perspective view of one potential embodiment of the fish filet accessory device of the present invention with a wrist strap in accordance with the disclosed architecture; and

FIG. 4 illustrates a perspective view of one potential embodiment of the fish filet device of the present invention in use in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improve fish preparation tool. There also exists a long-felt need in the art for a fish filet device that allows a user to more easily and securely control a fish, while attempting to filet said fish. Additionally, there exists a long-felt need in the art for a fish filet device that is securely retained on the user, such that the device cannot slip out of a user’s hand during use.

The subject matter disclosed and claimed herein, in one embodiment thereof, comprises a fish filet accessory device. The device is primarily comprised of a body having a first end and a second end, a grip and a wrist strap. The first end is further comprised of a removable or fixedly-attached cap, that is further comprised of a fixedly-attached loop that can receive a clip of a wrist strap, to allow the strap to removably-attach to the loop. The strap is also comprised of an adjustable fastener such as a buckle, snap-button, hook and loop surface, etc., that allows the looped body of the strap to tighten or loosen around the wrist of a user to secure the device to a user, such that the device cannot be dropped during use. The second end is further comprised of a removable or fixedly-attached cap, that has a plurality of teeth, which are preferably comprised of a durable metal, such as stainless steel or aluminum. In differing embodiments, the teeth may be fixedly-attached or removable (to allow for cleaning) and may be serrated or non-serrated.

To use the device, a user grasps the device via the grip with his or her non-dominant hand and thrusts the teeth of the second end into the skin of a fish. A user can then maintain pressure on the fish using the device, such that the fish cannot move upon the cutting surface it is resting on. With the fish is secured, a user can then use a knife to filet the fish as desired, without having to worry about the fish moving during cutting.

Accordingly, the fish filet device of the present invention is particularly advantageous as it provides an improved tool to aid in the preparation of fish fileting. Further, the device ensures a user can secure a fish during the fileting process to prevent the fish from moving. As a result, the chance of the fish slipping on the cutting surface is greatly reduced, which then reduces the possibility of a user accidently cutting him or herself with the knife.

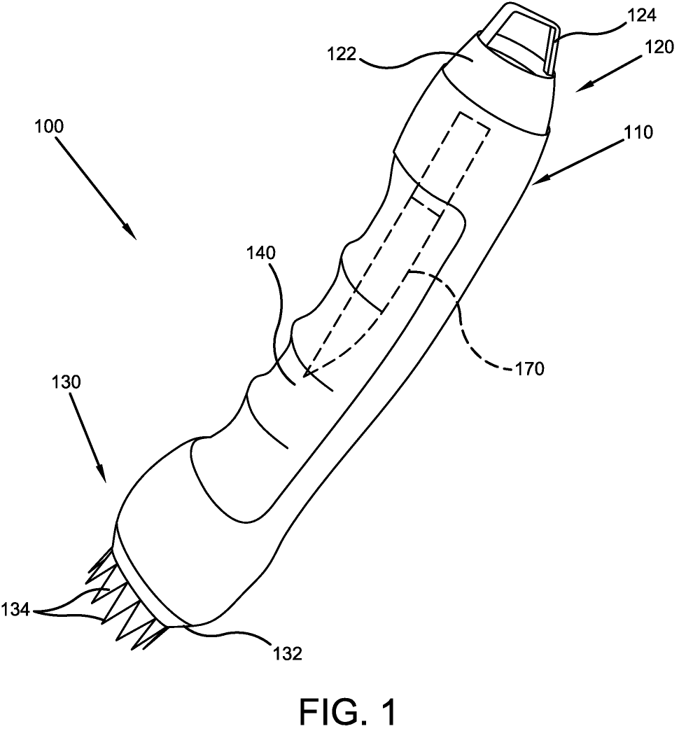

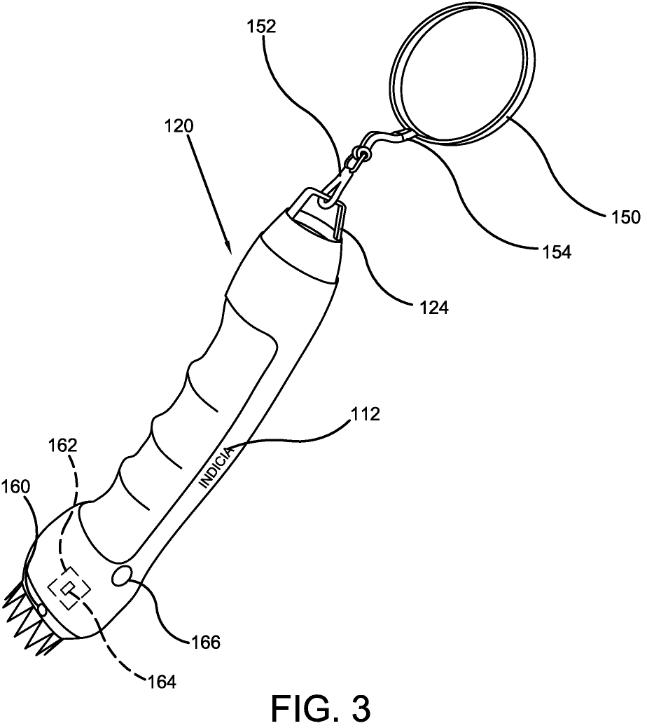

Referring initially to the drawings, FIG. 1 illustrates a perspective view of one embodiment of the fish filet accessory device 100 of the present invention. The device 100 is primarily comprised of a body 110 having a first end 120 and a second end 130, a grip 140 and a wrist strap 150, as best shown in FIG. 3. The body 110 is preferably generally cylindrical in shape, or any other suitable shape as is known in the art, and is preferably manufactured from a durable metal, such as but not limited to, stainless steel or aluminum, etc., or any other suitable metal as is known in the art. The body 110 may additionally or alternatively be made of a wood or plastic material such as, but not limited to, an acrylic, poly-carbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable plastic material as is known in the art. Additionally, the body 110 preferably floats on water, and may be a solid structure or hollowed out.

In addition, the body 110 may be transparent, semi-transparent or opaque in differing embodiments. Furthermore, the body 110 may be comprised of any number of indicia 112 (shown in FIG. 3) in the form of patterns, logos, emblems, images, symbols, designs, letters, words, characters, animals, advertisements, brands, etc., that may or may not be fish or fish preparation tool/brand related. Additionally, in one embodiment the body 110 may be hollow, such that a knife 170 which can be used to filet fish can be stored within the body 110 and removed when needed by removing a cap 122, 132 from the body 110. The grip 140 may further have any suitable texture as is known in the art that promotes a secure grip, and may also be contoured to receive the fingers of a user.

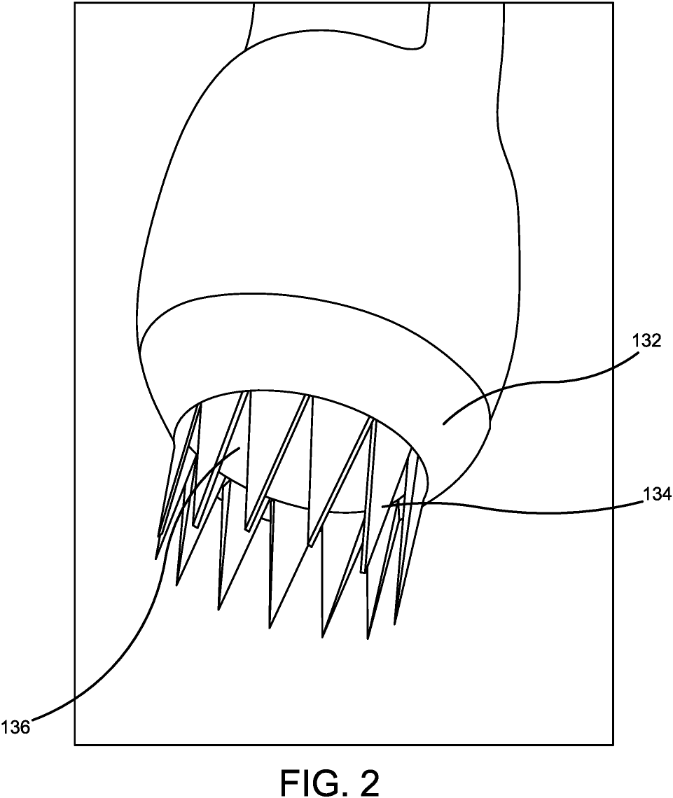

FIG. 2 illustrates an enhanced perspective view of the second end 130 of the fish filet device 100 of the present invention. The second end 130 is further comprised of a removable or fixedly-attached cap 132, wherein the bottom surface 136 of the cap 132 has a plurality of teeth 134. The teeth 134 are preferably comprised of a durable metal, such as stainless steel or aluminum, etc., or any other suitable metal as is known in the art, and may be fixedly-attached or removable (to allow for cleaning) from the bottom surface 136 in differing embodiments. In addition, the teeth 134 may be serrated or non-serrated in differing embodiments.

In one embodiment, the bottom surface 136, any surface of the cap 132, or any surface of the body 110 may further be comprised of at least one LED light 160 (shown in FIG. 3) that aids in illuminating a fish 12 and/or a cutting area on which the fish 12 is prepared. The at least one LED 160 is further powered by an internal battery 162. The battery 162 may be a disposable battery or a rechargeable battery in the form of an alkaline, nickel-cadmium, nickel-metal hydride battery, etc., such as any 3V-12 volts DC battery or other conventional battery such as A, AA, AAA, etc., that supply power to the device 100. Throughout this specification the term “battery” may be used interchangeably to refer to one or more wet or dry cells or batteries of cells in which chemical energy is converted into electricity and used as a source of DC power. References to recharging or replacing the battery 162 may refer to recharging or replacing individual cells, individual batteries of cells, or a package of multiple battery cells as is appropriate for any given battery technology that may be used. In another embodiment, the device 100 may be wireless, wherein the battery 162 can be recharged by a USB port 164 located on the cap 132 and/or body 110. In differing embodiments, the USB port 164 may be a USB-A, USB-B, Micro-B, Micro-USB, Mini-USB, or USB-C port, etc. In addition, the port 164 may receive a 9v/12v power supply. Furthermore, in order to activate/deactivate the light 160, a power button 166 is located on the body 110.

FIG. 3 illustrates a perspective view of one embodiment of the fish filet device 100 of the present invention with the wrist strap. The first end 120 is further comprised of a removable or fixedly-attached cap 122, that is further comprised of a fixedly-attached loop 124. The loop 124 can further receive a clip 152 of a wrist strap 150, to allow the strap 150 to removably attach to the loop 124. In differing embodiments, the strap 150 may be made of a plurality of fabrics, such as but not limited to: vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc. The strap 150 is further comprised of an adjustable fastener 154, such as a buckle, snap-button, hook and loop surface, etc., that allows the looped body of the strap 150 to tighten or loosen around the wrist of a user. In this manner, the strap 150 secures the device 100 to a user, such that the device 100 cannot be dropped during use.

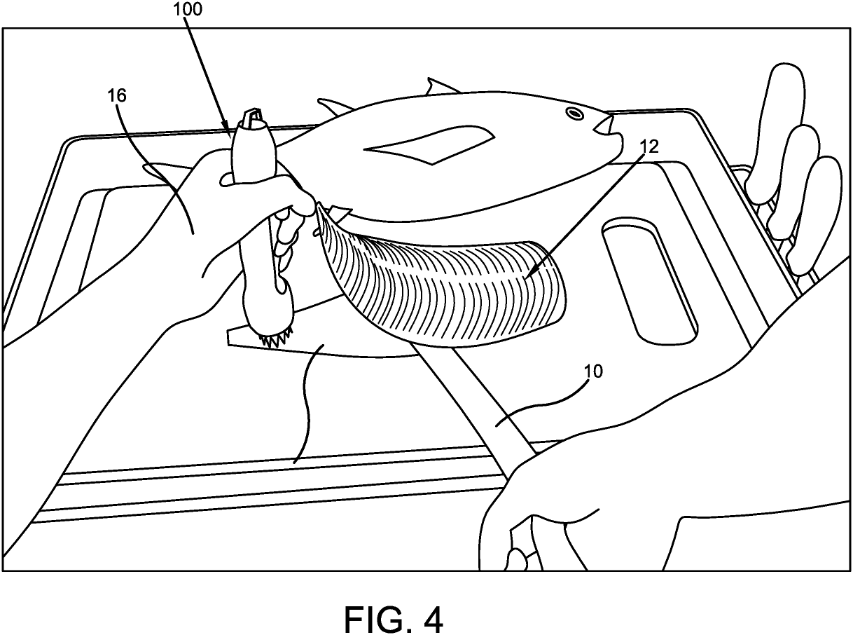

FIG. 4 illustrates a perspective view of one embodiment of the fish filet device 100 of the present invention being pressed against the skin 14 of a fish 12, in order to aid in the fileting process of the fish. In order to use the device 100, a user simply grasps the device 100 via the grip 140 with his or her non-dominant hand 16. Then, the user thrusts the teeth 134 of the second end 130 into the skin 14 of a fish 12. A user can then maintain pressure on the fish 12 using the device 100, such that the fish 12 cannot move upon the cutting surface. With the fish 12 secured, a user can then use a knife 10 to filet the fish 12 as desired, without having to worry about the fish 12 moving during cutting/fileting.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fish filet device” and “device” are interchangeable and refer to the fish filet device 100 of the present invention.

Notwithstanding the forgoing, the fish filet device 100 of the present invention and its various components can be of any suitable size and configuration as is known in the art without affecting the overall concept of the invention, provided that they accomplish the above-stated objectives. One of ordinary skill in the art will appreciate that the size, configuration and material of the fish filet device 100 as shown in FIGS. 1-4 is for illustrative purposes only, and that many other sizes and shapes of the fish filet device 100 are well within the scope of the present disclosure. Although the dimensions of the fish filet device 100 are important design parameters for user convenience, the fish filet device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fish filet accessory device comprising:
a body comprising a first end and a second end;
a textured grip positioned on the body;
a wrist strap secured to the first end; and
a cap secured to the second end, wherein a bottom surface of the cap comprises a plurality of teeth, and further wherein the plurality of teeth is used to secure a fish while fileting the fish.

2. The fish filet accessory device of claim 1, wherein the body is generally cylindrical in shape.

3. The fish filet accessory device of claim 2, wherein the body is hollow.

4. The fish filet accessory device of claim 3, wherein the body comprises a knife, stored within the body.

5. The fish filet accessory device of claim 4, wherein the body comprises indicia.

6. The fish filet accessory device of claim 5, wherein the body comprises a plurality of contours to receive a user’s fingers.

7. The fish filet accessory device of claim 1, wherein the wrist strap secures the fish filet accessory device to a user’s wrist during use.

8. The fish filet accessory device of claim 7, wherein a fixedly attached loop is secured to the cap.

9. The fish filet accessory device of claim 8, wherein the fixedly attached loop receives a clip, which allows the wrist strap to secure to the fixedly attached loop.

10. The fish filet accessory device of claim 9, wherein wrist strap comprises an adjustable fastener that allows the wrist strap to tighten or loosen around the user’s wrist.

11. The fish filet accessory device of claim 1, wherein the plurality of teeth are serrated.

12. The fish filet accessory device of claim 1, wherein the bottom surface of the cap comprises at least one LED light.

13. The fish filet accessory device of claim 12, wherein the body comprises a power button to activate and deactivate the at least one LED light.

14. A fish filet accessory device comprising:
a body comprising a first end and a second end;
a textured grip and contours for a user’s fingers positioned on the body;
at least one LED positioned on the body and powered via an internal battery;
a wrist strap secured to the first end; and
a cap secured to the second end, wherein a bottom surface of the cap comprises a plurality of teeth, and further wherein the plurality of teeth is used to secure a fish while fileting the fish.

15. The fish filet accessory device of claim 14, wherein the internal battery is comprised of a USB port that can be used to recharge the internal battery.

16. The fish filet accessory device of claim 14, wherein the body is hollow such that a knife can be stored within the body.

17. A fish filet accessory device comprising:
a body comprising a first end and a second end;
a textured grip and contours for a user’s fingers positioned on the body;
at least one LED positioned on the body and powered via an internal battery, wherein the internal battery comprises a USB port that can be used to recharge the internal battery;
a wrist strap secured to the first end, wherein the wrist strap is further comprised of an adjustable fastener that allows the wrist strap to tighten or loosen around a wrist of a user; and
a cap secured to the second end, wherein a bottom surface of the cap comprises a plurality of serrated teeth, and further wherein the plurality of serrated teeth is used to secure a fish while fileting the fish.

18. The fish filet accessory device of claim 17, wherein the body is hollow such that a knife can be stored within the body.

19. The fish filet accessory device of claim 17, wherein the adjustable fastener is a buckle, a snap-button, or a hook and loop surface.

20. The fish filet accessory device of claim 17, wherein the fish filet device can be gripped by a non-dominant hand of a user and the plurality of serrated teeth can be thrust into a skin of a fish in order to ensure that the fish does not move on a cutting surface while the fish is being fileted.
